(19) United States
(12) Patent Application Publication
(10) Pub. No.: US 2018/0049467 A1
(43) Pub. Date: Feb. 22, 2018

(54) Dual Vertical Charcoal Heat Source

(71) Applicants: Brandon Arbiter Abdullatif, Oxnard, CA (US); Ward Maksoud, Santa Ana, CA (US); Alan T. Diab, Oxnard, CA (US); George T. Helou, Granada Hills, CA (US)

(72) Inventors: Brandon Arbiter Abdullatif, Oxnard, CA (US); Ward Maksoud, Santa Ana, CA (US); Alan T. Diab, Oxnard, CA (US); George T. Helou, Granada Hills, CA (US)

(21) Appl. No.: 15/238,467

(22) Filed: Aug. 16, 2016

(51) Int. Cl. A24F 1/30; H05B 1/02

(52) U.S. Cl. CPC A24F 1/30; H05B 1/0225

(57) ABSTRACT

A dual vertical charcoal heat source that has a base with a lower heating assembly, and a cover with an upper heating assembly. Also within the base is a cavity that can maintain a tray that holds a quantity of charcoal. The cover is hingedly attached such that when closed, the cover, along with the upper heating assembly is directly above the lower heating assembly. The cavity including or not including the tray with the charcoal is below both heating assemblies. Electrical power is applied which raises the temperature of the heating assemblies. The heat from the assembles is directed downward and heats the charcoal in the cavity/tray. The heat from the charcoal is then applied to the hookah to facilitate smoking tobacco through the hookah.

### TECHNICAL FIELD

The invention generally pertains to heating devices, and more particularly to a heat source that utilizes dual vertically oriented heat coils to apply heat to charcoal which in turn is used to provide heat to a hookah.

### BACKGROUND ART

A hookah is a single or multi-stemmed/hosed instrument for vaporizing and smoking flavored tobacco or cannabis, called shisha, whose vapor or smoke is passed through a water basin.

The waterpipe was either invented by an Irfan Shaikh of the Mughal Empire or originates form the time of the Safavid dynasty of Persia from where it eventually spread to the east into India. The hookah also soon reached Egypt and the Levant during the Ottoman dynasty from the neighboring Safavid dynasty, where it became very popular and where the mechanism was later perfected. The word hookah is a derivative of “huqqa”, an Arabia term. Outside its native region, hookah smoking has gained popularity throughout the world, especially among younger people.

In order to use a hookah, heat must be provided. Typically and preferably, the heat is supplied via charcoal which is integral or adjacent to the hookah. There are problems associated with the use of charcoal-supplied heat. One of the problems is that the charcoal often requires a long time to reach the usable temperature. For an individual who desires smoking from a hookah, the time spent waiting for the charcoal to heat is frustrating. Also working with charcoal can be difficult and messy. As a result, some prior art describes methods and/or devices that supply heat to a hookah without using charcoal.

It would be very beneficial if there was a means for providing charcoal-derived heat to a hookah or similar smoking device. Optimally, the charcoal could be easily prepared for use, and the time required to heat the charcoal to the required temperature would be significantly lowered. The means would preferably use electrical power, via a power cable, although battery power could also be used to allow the means to be used in locations where utility power is not available, such as many outdoor locations.

A search of the prior art did not disclose any literature or patents that read directly on the claims of the instant invention. However, the-following U.S. patents are considered related:

| U.S. PAT. NO. | INVENTOR | ISSUED |
|---|---|---|
| 5,367,950 | Sarich | 29 Nov. 1994 |
| 5,928,544 | Bennett | 27 Jul. 1999 |
| 8,550,091 | Yomtov et al | 8 Oct. 2013 |
| 8,983,282 | Bioshara | 17 Mar. 2015 |

The U.S. Pat. No. 5,367,950 patent discloses a rotisserie cooking unit having a centrally configured heat source, a pair of removable spit carriers and a pair of removable covers. The covers are configured to provide the function of covering and enclosing the unit and of opening up to serve as drop pans and ash catches.

The U.S. Pat. No. 5,928,544 patent discloses a cooking appliance having a hob surface that is provided with a hob heating element provided in the top surface of a base unit. The base unit is arranged to be capable of being raised above the level of the hob surface in order to expose a further heating element provided on the bottom surface of the base unit whereby to permit food to be cooked with heat from above or below. The heating elements may be of gas or electrical.

The U.S. Pat. No. 8,550,091 patent discloses a water pipe that includes a bowl for placing therein a smoking substance, a tube that fluidly connects the bowl to a base member, at least one hose connection port, in fluid communication with the base member, for connecting with at least one flexible hose, and an electric heating element disposed in the bowl for heating the smoking substance. The electric heating element being shaped as an inner periphery of the bowl, and a controller in electrical communication with the electric heating element. The controller controls electrical power applied to the electric heating element for heating the smoking substance to a temperature that vaporizes volatile aromatic components of the smoking substance without substantially causing combustion of the smoking substance.

The U.S. Pat. No. 8,983,282 patent discloses an electric heat for generating smoke from tobacco or the like in a hookah type smoking pipe. The electric heat is obtained from an electrically powered heating element which may be contained within a housing which in turn may be placed above the smoking chamber of the hookah, may be integral with the hookah or may comprise a free standing assembly adjacent to the hookah.

For background purposes and indicative of the art to which the invention relates, reference may be made to the following remaining patents found in the patent search.

| U.S. PAT. NO. | INVENTOR | ISSUED |
|---|---|---|
| 2,033,067 | Fromknecht | 3 Mar. 1936 |
| 3,316,389 | Markowitz | 25 Apr. 1967 |
| 3,742,838 | Luschen et al | 3 Jul. 1973 |
| 3,867,922 | Dahlquist | 25 Feb. 1975 |
| 3,954,433 | Holier | 4 May 1976 |
| 4,034,663 | Jenn et al | 12 Jul. 1977 |
| 4,164,175 | Burstein et al | 14 Aug. 1979 |
| 4,970,949 | Ferrara, Jr. et al | 20 Nov. 1990 |
| 4,972,766 | Anetsberger | 27 Nov. 1990 |
| 5,154,115 | Kian | 13 Oct. 1992 |
| 5,284,671 | Stewart | 8 Feb. 1994 |
| 5,363,748 | Boehm et al | 15 Nov. 1994 |
| 5,606,905 | Boehm et al | 4 Mar. 1997 |
| 6,022,200 | Myers | 8 Feb. 2000 |
| 6,116,150 | Greenfield, Jr. | 12 Sep. 2000 |
| 6,918,429 | Lin et al | 19 Jul. 2005 |
| 7,823,577 | Babjak | 2 Nov. 2010 |
| 8,479,746 | Tannous | 9 Jul. 2013 |
| 8,485,091 | Schon | 16 Jul. 2013 |
| 8,631,739 | Reischmann et al | 21 Jan. 2014 |
| 2009/0200291 | Haas et al | 13 Aug. 2009 |
| 2010/0212679 | Bishara | 26 Aug. 2010 |
| 2012/0090476 | Wang et al | 19 Apr. 2012 |
| 2014/0352553 | Guckenberger et al | 4 Dec. 2014 |
| 2015/0183074 | Bucher et al | 2 Jul. 2015 |
| 2015/0320258 | Huang et al | 12 Nov. 2015 |
| 2016/0007799 | Steeb | 14 Jan. 2016 |

### DISCLOSURE OF THE INVENTION

A dual vertical charcoal heat source (DVCHS) that functions in combination with a pulverized leaf water-based smoking device, which is known as a hookah. The DVCHS provides the required heat to facilitate the smoking of the pulverized leaf, such as tobacco, through the hookah by heating/vaporizing the tobacco. The DVCHS is comprised of base in which a cavity or a cavity with a tray is located. Within the cavity/tray is placed a quantity of charcoal, and a cover is hingedly attached above the cavity/tray. Located above the cavity/tray on the base is a lower heating assembly, and located within the cover, and oriented directly above the lower heating assembly when the cover is closed, is an upper heating assembly. Electrical power is applied, via a power cable, to the DVCHS. The electrical power causes the heating assemblies to rise in temperature, thereby transferring the heat to the charcoal which in turn provides heat to the hookah.

Additionally, controls allow the DVCHS to be turned on or off and to selectably determine the amount of heat that is produced. An optional built-in timer provides a means by which the duration the DVCHS is in operation for to also be selectably determined.

In view of the above disclosure, the primary object of the invention is to provide a dual vertical charcoal heat source that can quickly and easy provide the charcoal-derived heat required when using a hookah.

In addition to the primary object, it is also an object of the invention to provide a dual vertical charcoal heat source that:
is easy to use,
is safe,
can significantly reduce the amount of time usually required to heat charcoal for hookah heating,
can be used with various types/styles of hookahs or other smoking devices,
does not affect the taste of tobacco smoked in a hookah,
does not require a large amount of power,
is long-lasting and durable,
can be used around the world,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan front view of a Dual Vertical Charcoal Heat Source (DVCHS) with the cover in a lowered/closed position.

FIG. 2 is a top plan front view of the DVCHS with the cover in a raised/open position and showing charcoal in the tray located within the base.

FIG. 3 is a top plan rear view of the DVCHS with the cover in a lowered/closed position, and showing the power cable extending from the base and power connecting wires between the base and the cover in a shunt configuration.

FIG. 4 is an elevational view of the (DVCHS) adjacent a hookah.

### BEST MODE FOR CARRYING OUT THE INVENTION

The best mode for carrying out the invention is presented in terms that disclose a preferred embodiment of a dual vertical charcoal heat source (DVCHS 10). When smoking a pulverized leaf substance, such as tobacco, heat is always required. Certain devices, such as a hookah which consists of a free-standing structure with at least one hose that functions with water to facilitate the smoking, require a constant specific amount of heat to operate property. The heat that is supplied to a hookah typically comes from charcoal which can provide constant long-lasting heat. One of the major drawbacks to using charcoal is that it requires preparation, can be complicated and usually does not heat up quickly. Both of these are time consuming, which is not optimal when a person or persons want to simply indulge in the act of smoking without complication or hindrance. The preparation of charcoal heating can be solved by simply pre-arranging everything that is necessary. The complication and duration of heating charcoal is more difficult. The DVCHS 10 solves this problem by providing charcoal heating for a hookah that is easy to use and significantly reduces the amount of time usually required to heat the charcoal.

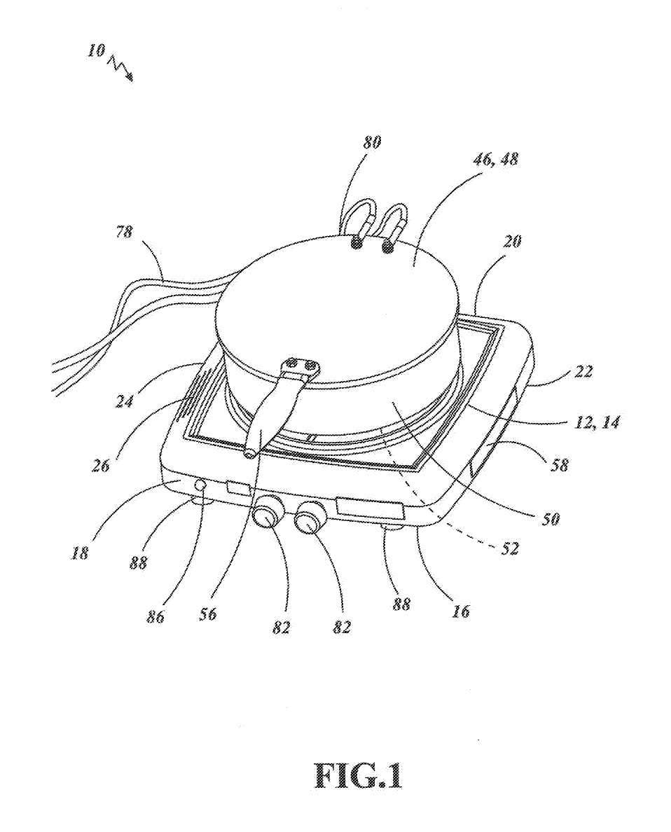

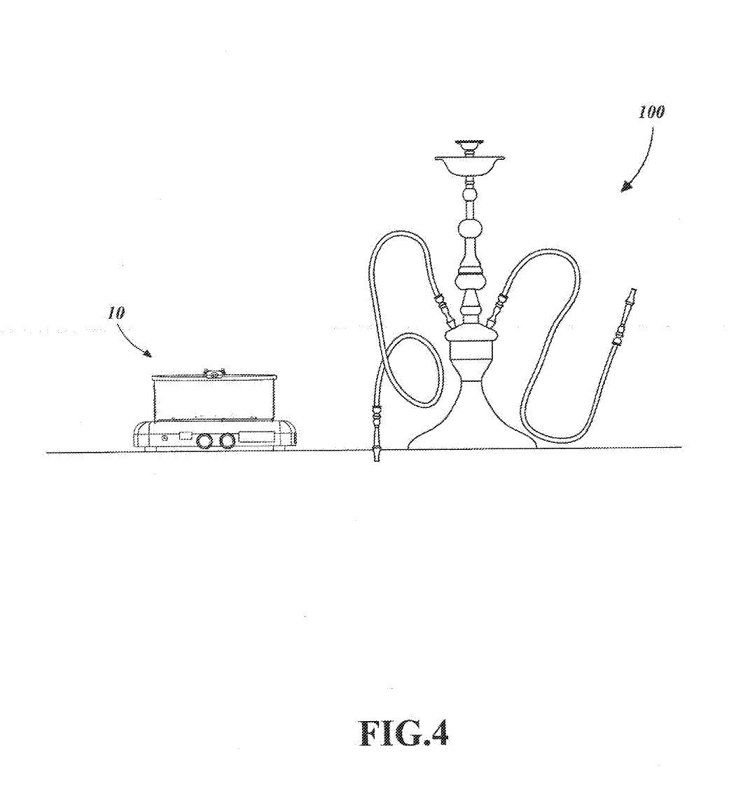

The DVCHS 10, as shown in FIGS. 1-4, is comprised of two major elements: a base 12 that houses a lower heating assembly 32, and a cover 46 housing and upper heating assembly 66. The DVCHS 10 functions in combination with a water-based pulverized leaf smoking device, which is commonly known as a hookah, as shown in FIG. 4. The DVCHS 10 provides heat that facilitates the smoking of the pulverized leaf, such as tobacco, through the hookah. The DVCHS 10 functions by heating charcoal which is then transferred to the hookah. Preferably, the DVCHS 10 is placed adjacent or near the hookah 100, as shown in FIG. 4, for easy transfer over a short distance, but, if desired or required, the DVCHS 10 can be placed at any distance from the hookah 100.

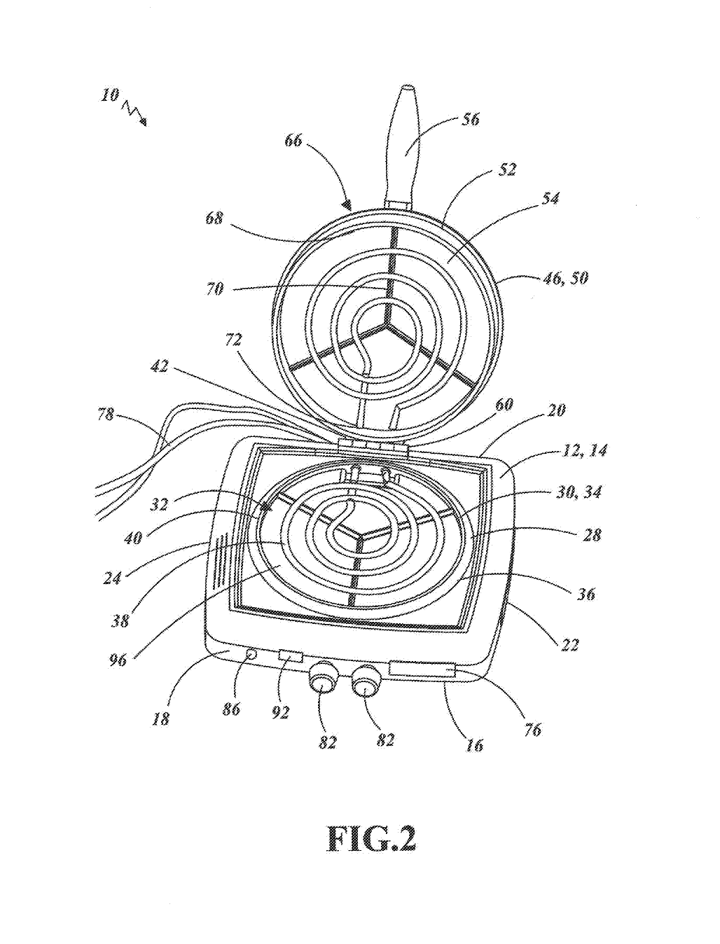

As shown in FIGS. 1-4, the base 12 is comprised of an upper surface 14, a lower surface 16, a front edge 18, a rear edge 20, a right edge 22 and a left edge 24. The base 12 is preferably square shaped but can be any shape. For the purpose of this disclosure, a square shaped base 12 is described and shown. Preferably, on the lower surface 16 of the base 12 is at. least one base support 88, as shown in FIGS. 2 and 4. The base support(s) 88 maintains the DVCHS 10 elevated above, with the lower surface 16 not in direct contact with, a surface upon which the DVCHS 10 is placed. Located on the upper surfaced 14 of the base 12 is an opening 28 that provides access to a cavity 30 which extends downward into the base 12. Also, as shown in FIG. 2, a sliding drawer 58 can extend outward, from either the right or left edge 22,24 or the rear edge 20 of the base 12. The sliding drawer 58 facilitates the collecting, removing and disposing of charcoal ashes from the DVCHS 10.

The lower heating assembly 32, as shown in FIG. 2, is located within the cavity 30 on the base 12. Optionally, a tray 34 can be inserted and maintained within the cavity 30. A perimeter ring 36 extends around the perimeter of the opening 28. A lower heat coil is located above, and is attached to, a support frame 40 which is attached to the perimeter ring 36. Preferably, the support frame 40 is a metal, three-point structure, although other designs can also be effectively utilized. As the rear of the heat coil extends outward a dual-prong power interface 42. As shown in FIG. 2, the heat coil 38 and support frame 40 are oriented above the cavity 30 or cavity and tray 34. The heat coil 38, support frame 40 and perimeter ring 36 are attached by a hinge 60 to the upper surface 14 at the rear of the base 12, which allows the coil, frame and ring to be lifted upward, thereby providing access to the cavity 30 or cavity and tray 34.

The cover 46, as shown in. FIGS. 1-4, has an upper surface 48, an outer perimeter side wall 50, an inner perimeter side wall 52, an interior 54, and a handle 56 that extents outward from the outer side wall at the front. The handle 56 can be integrally attached to the cover 46, or can be attached by attachment means (not shown) such as a screw(s) or a nut and bolt combination(s). The cover 46 is preferably circular shaped, but can also be other shapes. For the purpose of this disclosure, a circular cover is described and shown. The cover 46 is dimensioned to substantially enclose the opening 28, cavity 30 and lower heating assembly 32. The cover 46 can be raised and lowered, and is maintained in place, by the hinge 60 at the rear of the base 12. The hinge 60, which maintains both the lower heating assembly 32 via the ring 36 and the cover 46 is attached to the upper surface 14 of the base 12 by attachment means 62 which can include screws, nuts and bolts, welding, an adhesive or other means.

The upper heating assembly 66, as shown in FIG. 2, is located within the interior 54 of the cover 46. The assembly 66 comprises an upper heat coil 68 that is located below and is attached to a support frame 70 which is attached to the inner perimeter side wall 52 of the cover 46. As with the support frame 40 on the lower heating assembly 32, the upper support frame 70 is preferably a metal three-point structure, although other designs can also be utilized. Also, as on the lower heat coil 38, a dual prong power interface 72 extends rearward from the heat coil 68.

When the cover 46 is lowered/closed, the upper heating assembly 66 is oriented directly above the lower heating assembly 32 such that the heat produced by both heating assemblies is directed downward to the tray 34 within the cavity 30. Air slots 26, as shown in FIG. 2, can be placed at various locations on the base 12 and/or cover 46 to provide ventilation.

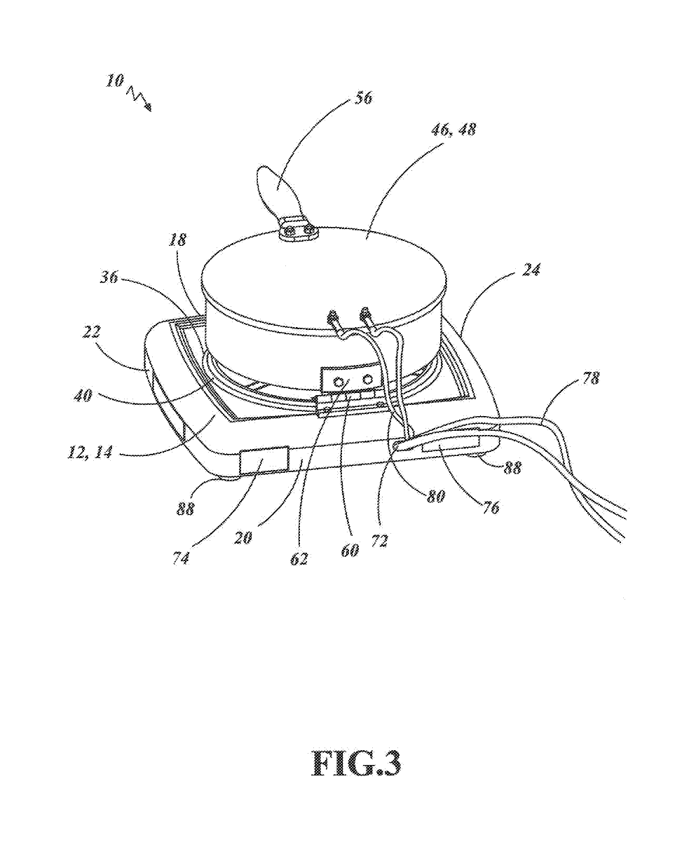

Electrical power is applied via a power cable 78 that extends from the rear of the base 12, as shown in FIG. 3. From the base 12, power is applied to the lower heating assembly 32 within the base 12, and then, via connecting wires 80 in a shunt configuration, to the upper heating assembly 66 in the cover 46. The electrical power causes the heating assemblies 32,66 to rise in temperature, thereby transferring the heat to charcoal 96 that is placed within the cavity 30 or cavity and tray 34 in the base 12. The heated charcoal 96 in turn provides the heat to the hookah.

In order to facilitate the insertion of charcoal into the tray prior to use, or removal of charcoal after use, and for cleaning, the upper heat coil 38, support frame 40 and ring 36 can be raised from the rear, via the hinge 60. If the tray 34 is utilized, it can be lifted up and out of the cavity 30. It is important to note that only a single hinge 60 is utilized for both the lower heating assembly 32 and for the cover 46/upper heating assembly 66.

In order to add to the functionality of the DVCHS 10, there can be controls 82, as shown in FIGS. 1, 2 and 4, for turning the DVCHS 10 on or off, and selectably determining the amount of heat is applied to the charcoal 96. An indicator light 86 can be used to show if the DVCHS 10 is on or off.

Additionally, a built-in timer 92 can be included. The timer 92, as shown in FIG. 3, allows the duration that the DVCHS 10 applies heat to be selectably, determined. Preferably the timer 92 has a range of 0-60 minutes.

It should be noted that while the DVCHS 10 has been disclosed with the preferred elements and functionality, other modifications, including adding or subtracting elements, can be presented. For example, while utility-supplied power via the power cable is optimal, power supplied from a battery, as shown in FIG. 2, or solar power 76, as shown in FIG. 3, can also be utilized. For certain applications, such as use of the DVCHS 10 at an outdoor or remote location, battery power or solar power might be the only power available, Also, even though the DVCHS 10 is particularly effective at providing charcoal-derived heat to a hookah, the DVCHS 10 can also be used to provide charcoal heat to other types of smoking devices, or other non-smoking devices that have similar heat requirements.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A dual vertical charcoal heat source that comprises upper and lower heating assemblies that heat charcoal which in turn provides heat to a pulverized leaf smoking device to facilitate the smoking of a pulverized leaf through the smoking device.

2. The dual vertical charcoal heat source as specified in claim 1 wherein said lower heating assembly is located in a base, and said upper heating assembly is located in a cover.

3. The dual vertical charcoal heat source as specified in claim 2 wherein said cover is hingedly attached to said base.

4. The dual vertical charcoal heat source as specified in claim 1 wherein said upper and lower heating assemblies are heated by electrical power via a power cable, where power initially enters said base and then is applied to said cover by connecting wires in a shunt configuration.

5. A dual vertical charcoal heat source (DVCHS) that functions in combination with a water-based pulverized leaf smoking device, wherein said DVCHS provides heat that facilities the smoking of the pulverized leaf through the smoking device by heating/vaporizing the pulverized leaf, wherein said DVCHS is comprised of a base having a cavity into which a quantity of charcoal is placed, and a cover, wherein located in said base is a lower heating assembly, and in said cover/lid is an upper heating assembly, wherein electrical power is applied, via a power cable, to said DVCHS, wherein the electrical power causes said heating assemblies to rise in temperature, thereby transferring the heat to the charcoal which in turn provides heat to the smoking device.

6. The dual vertical charcoal heat source as specified in claim 5 wherein said base is square shaped, and said cover/lid is circular shaped.

7. The dual vertical charcoal heat source as specified in claim 5 wherein said base, and said cover are made of metal.

8. The dual vertical charcoal heat source as specified in claim 5 further comprising a tray located within a cavity in said base, wherein the tray maintains the charcoal within said DVCHS.

9. The dual vertical charcoal heat source as specified in claim 5 further comprising a handle that extends outward from said cover.

10. The dual vertical charcoal heat source as specified in claim 5 further comprising controls for turning said DVHS on or off, and selectably determining the amount of heat that is applied to the charcoal.

11. A dual vertical charcoal heat source (DVCHS) that functions in combination with a water-based pulverized leaf smoking device, wherein said DVCHS provides heat that facilitates the smoking of the pulverized leaf through the smoking device by heating/vaporizing the pulverized leaf, wherein said DVCHS is comprised of:
a) a base having an upper surface, a lower surface, a front edge, a rear edge, a right edge, a left edge, and an opening that provides access to a cavity that extends downward into said base from the upper surface.
b) a lower heating assembly that is located within the cavity, or on a tray in the cavity, on said base, a perimeter ring that extends around the perimeter of the opening on said base, a lower heat coil that is located above and is attached to a support frame which is attached to the perimeter ring, and a dual prong power interface that extends from the heat coil, wherein the heat coil and support frame are oriented above the cavity or cavity and tray, wherein the heat coil, support frame, and ring are attached to the upper surface of said base by a hinge at a rear location.
c) a cover having an upper surface, an outer perimeter side wall, an inner perimeter side wall, an interior, and a handle that extends outward from the outer perimeter side wall at a front-location, wherein said cover is dimensioned to substantially enclose the opening, cavity and lower heating assembly on said base, wherein said cover can be raised or lowered, and is maintained in place, by the hinge at a rear location, wherein the hinge is attached, by attachment means, to said cover and the perimeter ring on said base, and
d) an upper heating assembly that is located within the interior of said cover and comprises an upper heat coil that is located below sand is attached to a support frame which is attached to the inner perimeter side wall of said cover and a dual prong power interface that extends rearward from the heat coil, wherein when said cover is lowered/closed, the upper heating assembly is oriented directly above the lower heating assembly such that the heat produced by both heating assemblies is directed downward to the cavity or cavity and tray, wherein electrical power is applied, via a power cable, to the two heating assemblies, wherein the electrical power initially enters said base and then is applied to said cover by connecting wires in a shunt configuration, wherein the power causes the heating assemblies to rise in temperature, thereby transferring the heat to charcoal that is placed within the cavity/tray in said base, wherein the heated charcoal provides the heat to the pulverized leaf smoking device.

12. The dual vertical charcoal heat source as specified in claim 11 wherein said base is square shaped, and said cover is circular shaped.

13. The dual vertical charcoal heat source as specified in claim 11 wherein said base and said cover are made of metal.

14. The dual vertical charcoal heat source as specified in claim 11 wherein the water-based pulverized leaf smoking device is comprised of a hookah.

15. The dual vertical charcoal heat source as specified in claim 11 wherein when the lower heat coil, support frame and ring are raised, via the hinge, the tray in the cavity is accessible and removable for insertion of charcoal prior to use, or for removal of charcoal after use and for cleaning.

16. The dual vertical charcoal heat source as specified in claim 11 wherein the heating assemblies support frames are each comprised of a metal, three-point structure.

17. The dual vertical charcoal heat source as specified in claim 11 further comprising controls for turning said DVCHS on or off, and selectably determining the amount of heat that is applied to the charcoal.

18. The dual vertical charcoal heat source as specified in claim 11 further comprising an on or off power indicator light.

19. The dual vertical charcoal heat source as specified in claim 11 further comprising a built-in timer that allows the duration that said DVCHS applies heat to be selectably determined.

20. The dual vertical charcoal heat source as specified in claim 19 wherein the timer has a range of 0-60 minutes.
